(19) United States
(12) Patent Application Publication
(10) Pub. No.: US 2011/0079987 A1
(43) Pub. Date: Apr. 7, 2011

(54) COLLAPSIBLE TROLLEY

(76) Inventor: San-Ching WU, Sindian City (TW)

(21) Appl. No.: 12/573,118

(22) Filed: Oct. 4, 2009

(51) Int. Cl. B62B 3/00

(52) U.S. Cl. 280/655

(57) ABSTRACT

A collapsible trolley includes a push rod, a holder, a central rod, a connecting rod, and two wheel rods. The central rod and the two wheel rods are coupled with a wheel, respectively. The push rod is movably connected with the holder, and connected with the central rod via a movable sleeve. The connecting rod is bent and inserted through the push rod, and has two ends connected with the two wheel rods. One end of each of the two wheel rods is pivotally connected to the central rod. When in use, the trolley is quickly extended to form a three-wheel trolley. When not in use, the trolley is able to be collapsed quickly, reducing its size.

### BACKGROUND OF THE INVENTION

(a) Field of the Invention

The present invention relates to a trolley, and more particularly to a trolley which is able to be collapsed quickly.

(b) Description of the Prior Art

A conventional shopping cart used in a shopping mall comprises a frame and a shopping basket. The frame is unable to be collapsed. When not in use, the shopping carts are lined up. This conventional shopping cart has wheels for movement. The user has to push the shopping cart with both hands for movement. It is not easy to move this shopping cart with only one hand. The movement is not flexible and convenient because of its size. Sometimes, it is easy to hit a surrounding person. In addition, the shopping carts occupy a lot of space when not in use. Accordingly, the inventor of the present invention has devoted himself based on his many years of practical experiences to solve these problems.

### SUMMARY OF THE INVENTION

The primary object of the present invention is to provide a collapsible trolley. When in use, the trolley is quickly extended to form a three-wheel trolley. With only one hand, the trolley is controlled to move with ease. The trolley is compact in size, preventing it from hitting a surrounding person. When not in use, the trolley is able to be collapsed quickly, reducing its size and being stored easily.

A further object of the present invention is to provide a collapsible trolley, which includes a push rod that is movably connected to a holder. The holder may be provided with a plurality of hooks or coupled with a shopping basket for carrying articles.

### BRIEF DESCRIPTION OF THE DRAWINGS

FIG. 1 is a perspective view of the present invention;

FIG. 2 is an exploded view of the present invention;

FIG. 3 is a schematic view of the present invention showing a holder lifted up;

FIG. 4 is a schematic view of the present invention showing a push rod pushed downward;

FIG. 5 is a schematic view of the present invention in a collapsed status;

FIG. 6 is a schematic view of the present invention provided with a pair of buckling bands; and

FIG. 7 is a schematic view of the present when in use.

### DETAILED DESCRIPTION OF THE PREFERRED EMBODIMENTS

Embodiments of the present invention will now be described, by way of example only, with reference to the accompanying drawings.

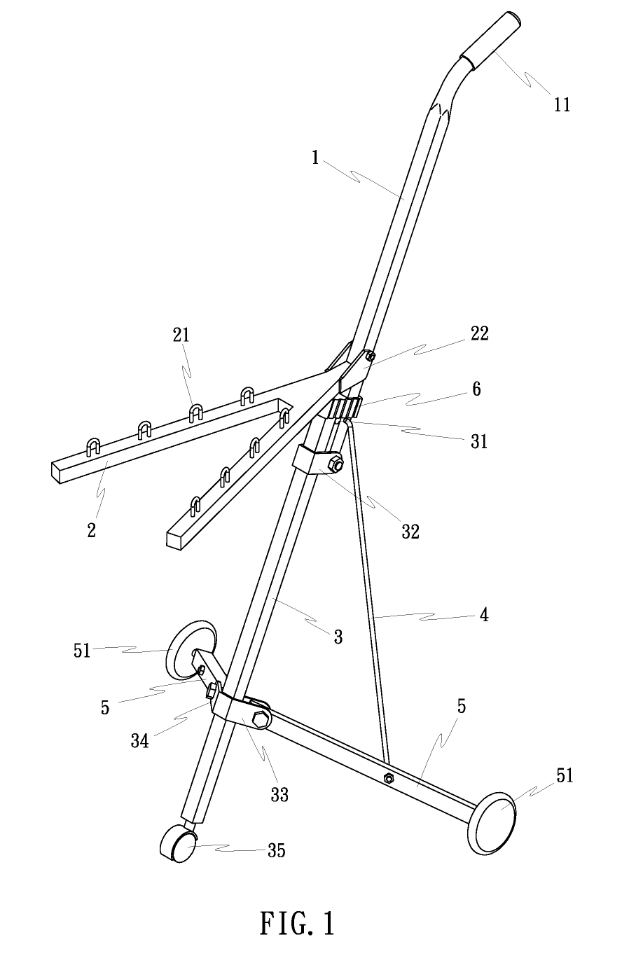

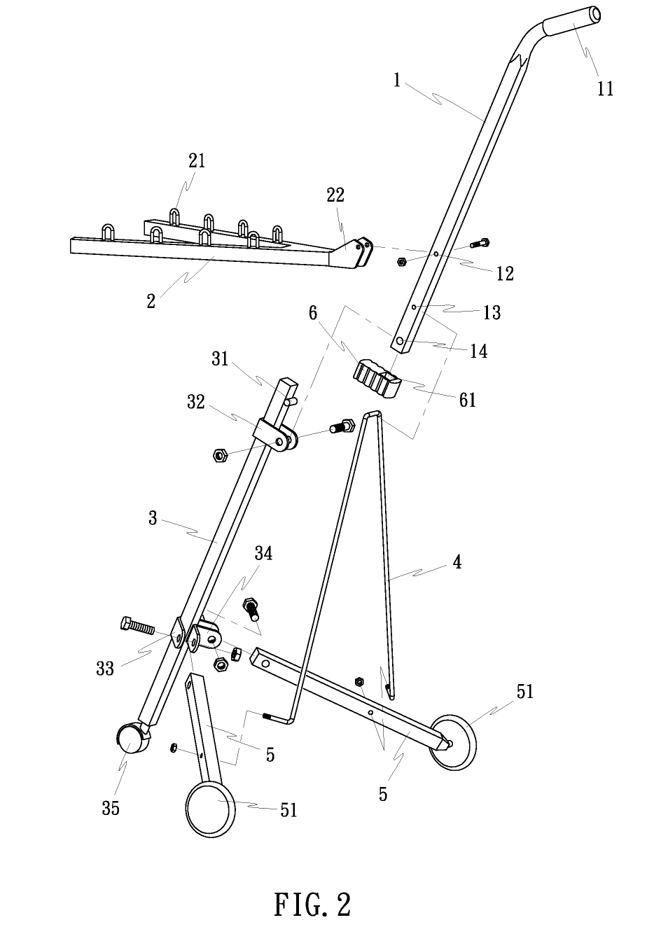

As shown in FIGS. 1 and 2, a collapsible trolley of the present invention comprises a push rod 1, a holder 2, a central rod 3, a connecting rod 4, and two wheel rods 5.

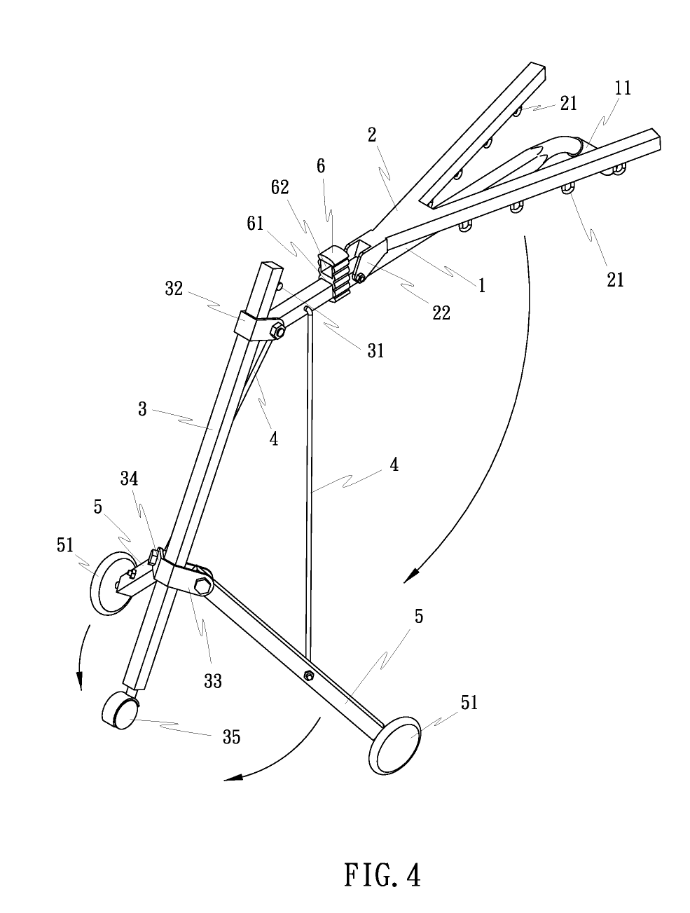

The push rod 1 has an upper end provided with a handle 11 and a lower end formed with a first through hole 12, a second through hole 13, and a third through hole 14 in sequence. The first through holes 11 is adapted for connection of the holder 2. The second through holes 12 is adapted for connection of the connecting rod 4. The third through holes 13 is adapted for connection of the central rod 3. The lower end of the push rod 1 is inserted in a movable sleeve 6. The movable sleeve 6 has a through hole 61 and a recess 62 facing downward, referring to FIG. 4.

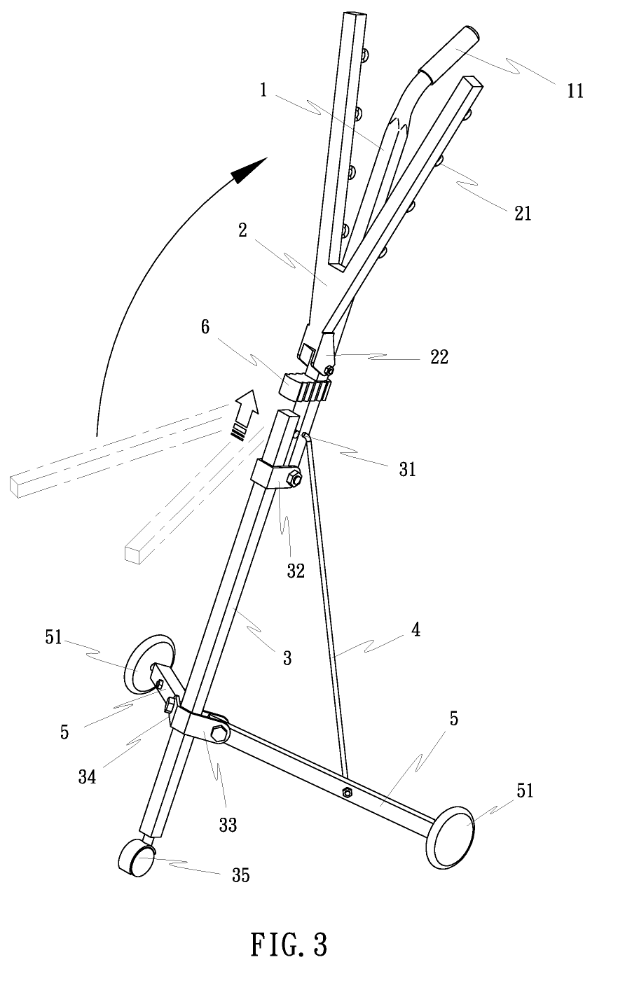

The holder 2 is a V-shaped rod in this embodiment and provided with a plurality of hooks 21 thereon. The holder 2 may be provided with a shopping basket. The holder 2 has a distal end provided with a first pivot seat 22 which is pivotally connected with the first through hole 12 of the push rod 1 such that the holder 2 is free to be lifted up, as shown in FIG. 3.

The central rod 3 comprises an upper end which is movably inserted in the recess 62 of the movable sleeve 6, a bulge 31 on an inner side of the upper end, a second pivot seat 32 near the upper end, two third pivot seats 33, 34 at a lower section thereof, and a wheel 35 at a lower end thereof. With the movable sleeve 6, the push rod 1 abuts upon the central rod 3, as shown in FIG. 1. The bulge 31 is located between the push rod 1 and the central rod 3. The second pivot seat 32 is pivotally connected with the third through hole 14. The two third pivot seats 33 and 34 are pivotally connected with the two wheel rods 5, respectively.

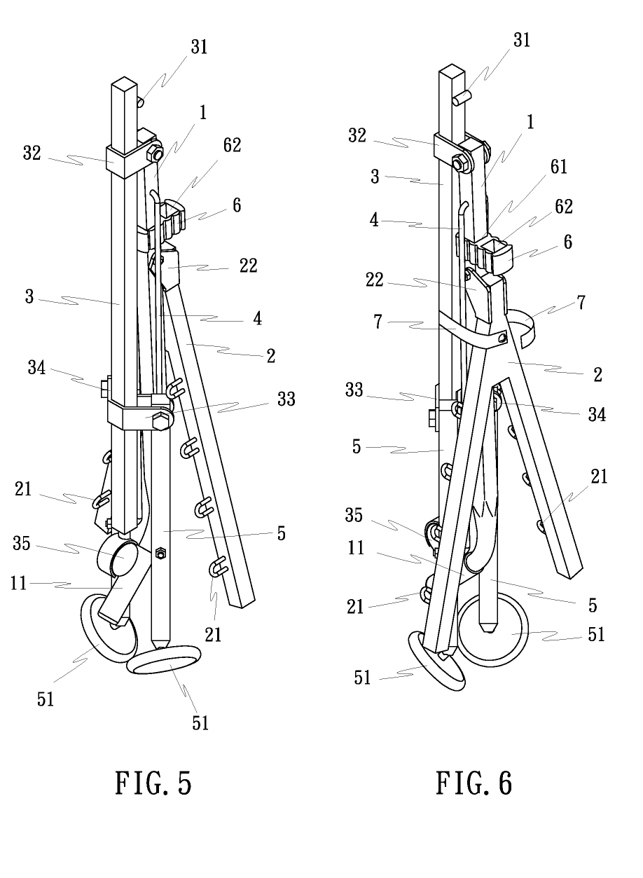

The connecting rod 4 is a V-shaped rod. The connecting rod 4 is bent and inserted through the second through hole 13, and has two ends connected to the two wheel rods 5. The connecting rod 4 is adapted to bring the two wheel rods 5, referring to FIG. 4, to be collapsed at two sides of the central rod 3, as shown in FIG. 5.

Each of the two wheel rods 5 has an upper end pivoted to the third pivot seat 33 or 34, a middle section connected with the connecting rod 4, and a lower end coupled with a wheel 51.

The rod 1, the holder 2, the central rod 3, the connecting rod 4, and the two wheel rods 5 are assembled to form the collapsible trolley. When in use, the trolley is quickly extended to form a three-wheel trolley, as shown in FIG. 1. With only one hand holding on the handle 11 of the push rod 1, the trolley is controlled to move with ease. The trolley of the present invention is compact in size, preventing it from hitting a surrounding person. When not in use, the trolley of the present invention is able to be collapsed quickly, reducing its size and being stored easily.

To collapse the present invention, the holder 2 is lifted up, referring to FIG. 3, for the central rod 3 to disengage from the movable sleeve 6. The push rod 1 is pushed downward, referring to FIG. 4, which brings the connecting rod 4 to drive the two wheel rods 5 to move inward and locate at the two sides of the central rod 3, referring to FIG. 5. The collapsed motion is simple and quick, and the size is reduced greatly after being collapsed.

As shown in FIG. 6, the central rod 3 may be provided with a pair of buckling bands or other fasteners to confine the collapsed trolley, preventing the parts of the trolley from loosening.

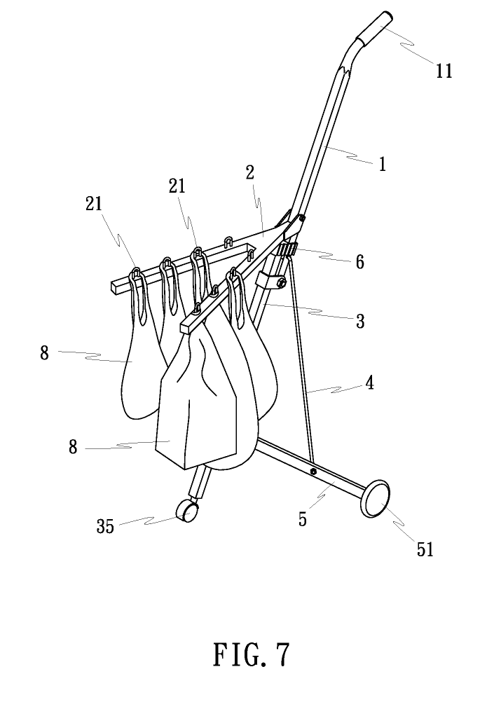

As shown in FIG. 7, the user may hang shopping bags 8 which are filled with articles on the hooks 21 of the holder 2 and control movement of the trolley with only one hand. Alternatively, the holder 2 may be coupled with a shopping basket (not shown in the drawings) to carry articles.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A collapsible trolley, comprising a push rod, a holder, a central rod, a connecting rod, and two wheel rods;
the push rod having an upper end provided with a handle and a lower end formed with a first through hole, a second through hole, and a third through hole in sequence, the first through holes being adapted for connection of the holder, the second through holes being adapted for connection of the connecting rod, the third through holes being adapted for connection of the central rod, the lower end of the push rod being inserted in a movable sleeve, the movable sleeve having a through hole and a recess facing downward;
the holder having a distal end provided with a first pivot seat which is pivotally connected with the first through hole of the push rod;
the central rod comprising an upper end which is movably inserted in the recess of the movable sleeve, a bulge on an inner side of the upper end, a second pivot seat near the upper end, two third pivot seats at a lower section thereof, and a wheel at a lower end thereof, the push rod abutting upon the central rod with the movable sleeve, the bulge being located between the push rod and the central rod, the second pivot seat being pivotally connected with the third through hole, the two third pivot seats being pivotally connected with the two wheel rods, respectively;
the connecting rod being a bent rod inserted through the second through hole of the push rod and having two ends connected to the two wheel rods;
the two wheel rods each having an upper end pivoted to one of the third pivot seats, a middle section connected with the connecting rod, and a lower end coupled with a wheel.

2. The collapsible trolley as claimed in claim 1, wherein the holder is a V-shaped rod provided with a plurality of hooks thereon.

3. The collapsible trolley as claimed in claim 1, wherein the holder is provided with a shopping basket.

4. The collapsible trolley as claimed in claim 1, wherein the connecting rod is a V-shaped rod.

5. The collapsible trolley as claimed in claim 1, wherein the central rod is provided with a pair of buckling bands.
